(19) United States
(12) Patent Application Publication
(10) Pub. No.: US 2025/0009469 A1
(43) Pub. Date: Jan. 9, 2025

(54) SECURE HANDPIECE AND METHOD FOR SECURING THE USE OF AN ENDODONTIC INSTRUMENT

(71) Applicants: Walid NEHME, BEIRUT (LB); MICRO-MEGA INTERNATIONAL, BESANCON (FR)

(72) Inventors: Walid NEHME, BEIRUT (LB); Stéphane CLAUDE, ROCHE (CH)

(73) Assignees: Walid NEHME, BEIRUT (LB); MICRO-MEGA INTERNATIONAL, BESANCON (FR)

(21) Appl. No.: 18/710,767

(22) PCT Filed: Sep. 27, 2022
(86) PCT No.: PCT/FR2022/051823

§ 371 Date: May 16, 2024

(30) Foreign Application Priority Data
Nov. 18, 2021 (FR) FR2112177

(51) Int. Cl. A61C 1/00; A61C 1/12; A61C 5/40

(52) U.S. Cl. CPC A61C 1/003; A61C 1/12; A61C 5/40

(57) ABSTRACT

A handpiece for endodontic practice, which is devised to drive a root canal instrument and includes: a control unit which runs a computer program, and a measuring element for measuring mechanical stresses experienced by the instrument, the measuring element is connected to the control unit. The computer program being configured to compare the mechanical stresses experienced by the instrument with respect to a predefined threshold, the predefined threshold preferably being a threshold permissible by the instrument. The mechanical stresses are at least axial stresses, and depending on the comparison between the axial stresses experienced by the instrument and the threshold: the computer program is programmed to adapt the driving of the instrument, and/or the handpiece including a warning element, and the computer program is programmed to activate the warning element.

### TECHNICAL FIELD

The invention relates to the technical field of endodontics.

### PRIOR ART

During an endodontic treatment, instrument breakage is one of the most common complications. The direct complications of such instrument breakage are of a clinical nature:
if it is possible to recover the broken instrument, the consequences are an increase in the treatment duration and potential weakening of the tooth by a reduction of thickness of the residual wall necessary to remove the broken instrument;
if it is not possible to recover the broken instrument, the consequences can (i) be linked to insufficient disinfection of the root canal system entailing post-operative pain, failure to heal, and therefore failure of the endodontic treatment, or (ii) be linked to the onset of an infectious process not existing at the time and resulting in pain and failure of the treatment in the medium term.

Occurrences of instrument breakage are generally reduced by the design of root canal instruments, in order to make them more resistant to the stresses exerted during endodontic treatment.

To limit the excessive stress experienced by the instrument, some handpieces driving the instrument are endowed with devices for control of the torque exerted by the motor on the instrument. However, that type of instantaneous measurement does not make it possible to prevent all types of breakage, such as breakage owing to fatigue or creep.

Moreover, in cases where the torque is measured by the motor itself, failure of the motor can lead to failure of the measurement, which would then not be detected. This principle contravenes the principles of securing in the field of automated systems.

### SUMMARY

One of the aims of the invention is to make up for the drawbacks of the prior art, by proposing a handpiece configured to best secure the use of the root canal instrument.

For that purpose, a handpiece for endodontic practise has been devised, designed to drive a root canal instrument and comprising:
a control unit running a computer program;
measuring means for measuring the mechanical stresses experienced by the instrument, connected to the control unit;
the computer program being configured to compare the mechanical stresses experienced by the instrument with respect to a predefined threshold, the predefined threshold being preferably a threshold permissible by the instrument.

According to the invention, the mechanical stresses are at least axial stresses, and depending on the comparison between the axial stresses experienced by the instrument and the threshold:
the computer program is programmed to adapt the driving of the instrument; and/or
the handpiece comprises warning means, and the computer program is programmed to activate the warning means.

In that way, the handpiece captures more information about the stresses experienced by the instrument, and notably via the measurement of the axial effort, which is the thrust or the axial traction which the practitioner transmits to the instrument.

The comparison can be made with respect to a predefined threshold, considered as representative of a value not to be exceeded regardless of the type of instrument mounted on the handpiece. Preferably, the predefined threshold is more specifically the threshold of stresses permissible by the instrument, such that the use of the handpiece is better adapted to the type of instrument used, chosen according to the treatment to be accomplished.

Of course, the value of those thresholds includes the necessary safety coefficients with respect to the plastic deformation or instrument breakage thresholds, in order to prevent breakage.

By means of that fuller knowledge of the stresses experienced by the instrument, the computer program is able to adapt the driving of the instrument, for example by reducing the speed of rotation when the stress reaches for example 70% or 80% of the threshold, so as to reduce the stresses experienced by the instrument. If the stress exceeds the threshold, then the speed can be drastically reduced. In that way, the risk of breakage is reduced.

Alternatively or complementarily, the computer program is able to activate the warning means in order to alert the practitioner to the level of stresses experienced by the instrument during the treatment. The warning means are for example an alphanumeric display of the stress experienced or the display of a gauge or a dial, on an interface available to the practitioner. Thus alerted to the level of the stresses experienced, the practitioner can himself adapt the parameters of use of the instrument: for example, himself reduce the speed of rotation of the instrument, or even reduce the thrust or the traction that he transmits to the instrument. He thus reduces the level of stresses experienced by the instrument, thereby avoiding its breakage.

In that way, the invention makes it possible to provide a handpiece for securing the use of the root canal instrument.

In one embodiment, the handpiece comprises a contra-angle designed to receive and drive the instrument, and the contra-angle comprises the measuring means. In that way, the measuring means are as close as possible to the instrument, which facilitates the measurement of the stresses and reduces measuring errors.

Advantageously, the measuring means are a dynamometer or extensometer, such as strain gauges, these means for measuring being proven and simple to implement.

To further secure the use of the instrument, the computer program is programmed to stop the driving of the instrument when the axial mechanical stress experienced by the instrument is greater than the threshold. In that way, the release is automatic and guarantees the securing of the instrument.

In one particular embodiment the computer program is programmed to activate additional warning means, like a visual alert such as a flash of light, or an audible alert such as an audible siren. This guarantees that the practitioner fully acts on the additional alert signal.

With the aim of simplicity of design, the control unit is connected to an interface configured for manual input of the permissible threshold.

With the aim of automation and reduction of the risk of input error, the computer program is programmed to search for the permissible threshold within a database of permissible thresholds according to an instrument reference and/or an instrument identifier.

In this mode, the control unit is connected to an interface configured for manual input of the instrument reference and/or the instrument identifier. This solution is easy to implement.

Alternatively, or preferably complementarily, the control unit is connected to means for reading the instrument reference and/or the instrument identifier. The inputting to be undertaken by the practitioner is then reduced, further reducing the risk of input error and facilitating the use of the handpiece.

Advantageously, the measuring means are configured to measure the stresses experienced by the instrument according to three axes of an orthonormal reference point. The knowledge of the forces and the momentums experienced by the instrument is then complete, which enables better prevention of breakage. Of course, the computer program is also programmed to adapt the driving of the instrument and/or activate the warning means depending on the comparison between the stresses experienced by the instrument according to three axes of an orthonormal reference point and the thresholds for each stress.

The invention also relates to a method for securing an instrument driven by an endodontic handpiece. According to the invention, the method comprises the following steps:
obtaining of a predefined threshold of mechanical stress, at least axial, the threshold being preferably a threshold permissible by the instrument;
measurement of the at least axial mechanical stress experienced by the instrument;
comparison between the axial mechanical stress experienced and the threshold;
depending on the comparison, adaptation of the driving of the instrument and/or issuance of an alert.

The implementation of such a method upon use of a root canal instrument makes it possible to avoid instrument breakage:
by changing the driving of the instrument, for example by reducing its speed of rotation if the stresses experienced become too great; and/or
by alerting the practitioner of this excessive level of stresses experienced, so he will himself adapt the use of the instrument, for example by reducing the efforts applied to the instrument or the speed of rotation.

### BRIEF DESCRIPTION OF THE DRAWINGS

FIG. 1 is a perspective view of a handpiece according to the invention.

FIG. 2 is a diagram illustrating such handpiece during use.

FIG. 3 is a detailed diagram of such handpiece during use.

### DETAILED DESCRIPTION

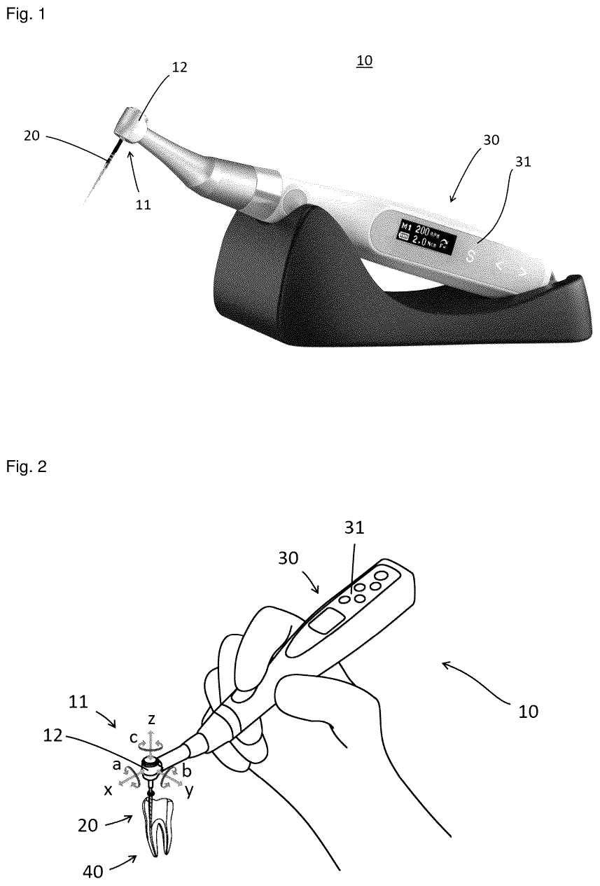

In reference to FIGS. 1 to 3, the invention concerns an instrument handpiece (10), configured to obtain the mechanical stresses experienced by a root canal instrument (20) during endodontic treatment carried out on a tooth (40).

For that purpose, the handpiece (10) comprises a control unit (30) running a computer program, and connected to means (11) for measuring mechanical stresses experienced by the instrument (20).

In order for the measurements of the stresses to be as accurate as possible, the means (11) for measuring are preferably arranged over a contra-angle (12) of the handpiece (10).

The means (11) for measuring are of any adapted type, and can be dynamometers or extensometers. Preferably, they are strain gauges, for example axial or in the form of rosettes. Indeed, these strain gauges are small, durable, and their output signal is easy to interpret.

Alternatively or complementarily to the torque around its axis of rotation, already available in the solutions of the prior art, the means (11) for measuring are, according to the invention, configured to capture at least the axial effort, notably of thrust or traction, experienced by the instrument (20).

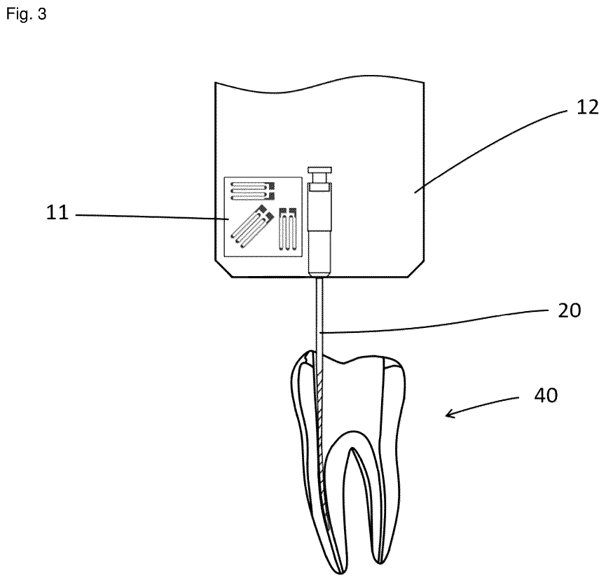

In reference to FIG. 2, the axis of the instrument (20) refers to its axis of revolution. The torque already taken into account in the solutions of the prior art is identified (c), and the axial effort analysed by the invention is identified (z).

Preferably, in order to hold as much information as possible about the conditions of use of the instrument (20), the means (11) for measuring are configured to measure the stresses experienced by the instrument (20) according to three axes of an orthonormal reference point. Still in reference to FIG. 2, it is a matter of capturing the efforts (x, y, z) and the torques (a, b, c). It is thus possible to completely obtain the wrench load experienced by the instrument (20).

On the basis of the information captured by the means (11) for measuring, the computer program is configured to compare the mechanical stresses experienced by the instrument (20) with respect to a predefined threshold.

In an initial simple mode, this is an absolute threshold, i.e. a threshold which does not depend on the type of instrument (20) used. The practitioner, or the manufacturer of the instrument (20), can define a stress threshold not to be exceeded, for example 2N, or even a torque of 0.01 Nm.

This mode does not require any tracking of the reference of the instrument (20) and is therefore the simplest to implement. In this mode, an interface (31) of the control unit (30) is configured so that the practitioner can manually input the stress threshold.

In a second, more elaborate embodiment, the predefined threshold is a threshold of stresses permissible depending on the type or the reference of the instrument (20). This means that the threshold is adapted depending on the type of each instrument (20), depending on its geometry, its material, and any heat treatments received.

In this second mode, the interface (31) can be configured for manual input of the reference of the instrument (20). Alternatively or complementarily, the handpiece (10) comprises means for reading the reference of the instrument (20), for example a barcode, a 2D code such as a QR code, or a RFID chip, which may be present on the instrument (20) or its packaging.

The computer program is then programmed to search, within a database of permissible thresholds, for the permissible threshold which corresponds to the reference of the instrument (20) that the practitioner is going to use. This database is filled with the information provided by the manufacturer of the instrument (20). This database is preferably saved in a memory located in the handpiece (10) and connected to the control unit (30).

This mode can be used alternatively or complementarily to the previous mode: if a treatment presents a certain difficulty, for example linked to the geometry of the root canal to be treated, the practitioner can choose to manually define a threshold lower than that stipulated by the manufacturer of the instrument (20).

In a third, even more elaborate mode, the threshold of permissible stresses is more specifically individually connected to each instrument (20). This mode is notably adapted to reusable instruments (20). Indeed, depending on the stresses experienced over time, the threshold of stresses permissible by the instrument (20) reduces, and becomes lower than the threshold of permissible stresses of a new instrument (20). The threshold of permissible stresses is impacted, for example, by the number of sterilisation cycles experienced by the instrument (20), by its total duration of use, or by the mechanical stresses experienced in previous uses.

This third mode requires that the handpiece (10) comprises means for reading a unique identifier of the instrument (20), for example a barcode, a 2D code such as a QR code, or a RFID chip present on the instrument (20).

The computer program is then programmed to search within a database of permissible thresholds to find the permissible threshold which corresponds to the particular instrument (20) that the practitioner is going to use. This database is filled with the user data collected by the handpiece (10), and the computer program adjusts the permissible threshold of the instrument (20) over time during its life cycle. In the same way, that database is preferably saved in a memory located in the handpiece (10), and connected to the control unit (30), and this third mode can be used alternatively or complementarily to the first or second mode.

Manual input is preferably possible in all cases, in order that a failure to read the reference or the identifier of the instrument (20) does not prevent the use of the handpiece (10).

Once the predefined threshold is obtained, the computer program compares it to the mechanical stresses experienced by the instrument (20) during its use. The result of the comparison can be used in different ways by the computer program: the driving of the instrument (20) is adapted, and/or warning means of the handpiece (10) are activated by the computer program.

The adaptation of the driving can consist of a progressive reduction in the speed and/or the torque applied to the instrument (20). In that way, the nearer the stresses experienced by the instrument (20) get to the predefined threshold, the more the instrument dynamic is going to be reduced with a view to not allowing it to exceed the permissible threshold, which would be synonymous with a high risk of instrument breakage.

Advantageously, the adaptation of the driving results in a cessation of the driving when the stresses experienced are greater than or equal to the predefined threshold. Thus, the practitioner cannot over-stress the instrument (20), which reduces the risk of breakage.

The warning means can be of different types. They can be a display, for example on the interface (31) of the control unit. The display may be the numerical value of the stress, a message, or even a gauge or a dial. During the treatment, the practitioner can oversee, at regular intervals, that he is stressing the instrument (20) reasonably and does not approach the threshold too much.

Preferably, the warning means are supplemented with additional warning means if the mechanical stresses experienced by the instrument (20) are greater than or equal to the threshold. These additional warning means can be audible, such as an audible siren, or visual such as a flash of light. These additional warning means guarantee that the practitioner is alerted when the threshold is reached, even if he does not pay attention to the basic warning means.

Furthermore, the handpiece (10) and the method according to the invention can be modelled differently without departing from the framework of the invention, which is defined by the claims. In particular, the means (11) for measuring can be modelled differently from a strain gauge, and can be of any type adapted to the present application.

In a variant not represented, the control unit (30) is connected to a database of stresses experienced, and the control unit records the measurements of stresses experienced by the instrument (20) over time.

According to another variant not represented, the warning means are not displayed by the interface (31) but by any other means available to the practitioner, such as an additional screen.

According to another variant not represented, the handpiece (10) comprises means of connection and communication with an external electronic hardware such as a computer, such that the control unit (30) can communicate with it. The computer program can comprise sub-programmes, some of which are run by the external computer, and the databases may for example be saved in a memory of the external computer.

Furthermore, the technical features of the different embodiments and variants mentioned above may be combined with each other, in their entirety or just for some of them. Thus, the handpiece (10) and the method may be adapted in terms of cost, functions and performance.

1-10. (canceled)

11. A handpiece for endodontic practice which is designed to drive a root canal instrument and comprises:
a control unit which runs a computer program;
measuring means for measuring mechanical stresses experienced by the instrument, which measuring means are connected to the control unit;
the computer program being configured to compare the mechanical stresses experienced by the instrument with respect to a predefined threshold;
wherein the mechanical stresses are at least axial stresses, and depending on the comparison between the axial stresses experienced by the instrument and the threshold:
the computer program is programmed to adapt the driving of the instrument; and/or
the handpiece comprises warning means, and the computer program is programmed to activate the warning means.

12. The handpiece according to claim 11, wherein the handpiece comprises a contra-angle designed to receive and to drive the instrument, and the contra-angle comprises the measuring means.

13. The handpiece according to claim 11, wherein the measuring means are a dynamometer or extensometer.

14. The handpiece according to claim 11, wherein computer program is programmed to:
stop the driving of the instrument; and/or
activate additional warning means;
when the axial mechanical stress experienced by the instrument is greater than the threshold.

15. The handpiece according to claim 11, wherein the control unit is connected to an interface configured for manual input of the threshold.

16. The handpiece according to claim 11, wherein the computer program is programmed to search for the permissible threshold within a database of permissible thresholds depending on at least one of:
a reference of the instrument, and
an identifier of the instrument.

17. The handpiece according to claim 16, wherein the control unit is connected to an interface configured for manual input of at least one of:
the reference of the instrument, and
the identifier of the instrument.

18. The handpiece according to claim 16, wherein the control unit is connected to means for reading at least one of:
the reference of the instrument or the identifier of the instrument.

19. The handpiece according to claim 11, wherein the measuring means are configured to measure the stresses experienced by the instrument according to three axes of an orthonormal reference point.

20. A method of securing of an instrument driven by an endodontic handpiece, comprising the following steps:
obtaining a predefined threshold of mechanical stress at least axial;
measuring the at least axial mechanical stress experienced by the instrument;
comparing between the axial mechanical stress experienced and the threshold; and
depending on the comparison, at least one of:
adapting the driving of the instrument, and
issuing an alert.
